(19) United States
(12) Patent Application Publication
(10) Pub. No.: US 2010/0307458 A1
(43) Pub. Date: Dec. 9, 2010

(54) Engine

(75) Inventor: Gou Asai, Osaka (JP)

Correspondence Address: STERNE, KESSLER, GOLDSTEIN & FOX P.L.L.C., 1100 NEW YORK AVENUE, N.W., WASHINGTON, DC, 20005, US

(73) Assignee: Yunmar Co. Ltd, Osaka (JP)

(21) Appl. No.: 12/864,466

(22) PCT Filed: Jan. 9, 2009
(86) PCT No.: PCT/JP2009/050174

§ 371 Date: Jul. 23, 2010

(30) Foreign Application Priority Data
Jan. 28, 2008 (JP) 2008 016178

(51) Int. Cl. F02D 41/06

(52) U.S. Cl. 123/491

(57) ABSTRACT

Provided is an engine which can certainly be started even in a very-low-temperature range. The engine comprises a plurality of cylinders, a fuel injection device which injects fuel to the respective cylinders, a combustion chamber temperature calculation means which calculates a temperature in a combustion chamber, a control means which starts the engine by normal operation which injects the fuel to all the cylinders by the fuel injection device or reduced-cylinder operation which injects the fuel to only specified cylinders by the fuel injection device. When starting the engine, the control means controls the engine to conduct the normal operation when the temperature in the combustion chamber calculated by the combustion chamber temperature calculation means is in the very-low-temperature range and to conduct the reduced-cylinder operation when the temperature in the combustion chamber comes into a low-temperature range.

### TECHNICAL FIELD

The present invention relates to an engine. In more detail, the present invention relates to a diesel engine which performs reduced-cylinder operation.

### BACKGROUND ART

Conventionally, there is well known reduced-cylinder operation in which fuel injection to specific cylinders is stopped. In the reduced-cylinder operation, fuel injection amount per cylinder is increased in comparison with normal operation so that combustion temperature is increased. Then, in the engine, the reduced-cylinder operation is performed at low-temperature starting so as to reduce cold smoke effectively.

The low-temperature starting is the engine starting in the case that combustion chamber temperature is in a low-temperature range (−10° C. to 0° C.). However, for example, a diesel engine mounted on a ship is required to be started certainly in so-called very-low-temperature range (−30° C. to −10° C.) widely lower than the freezing point. In the engine control device disclosed in the Japanese Patent Laid Open Gazette 2006-183493, the reduced-cylinder operation is performed at the low-temperature starting based on air fuel ratio. However, in the engine control device, the starting cannot be performed certainly in the very-low-temperature range (−30° C. to −10° C.).

### BRIEF SUMMARY OF THE INVENTION

### Problems to be Solved by the Invention

Then, the purpose of the present invention is to provide an engine which can be started certainly in the very-low-temperature range.

### Means for Solving the Problems

An engine of the present invention comprises: a plurality of cylinders; a fuel injection device which injects fuel to each of the cylinders; a combustion chamber temperature calculation means which calculates temperature in a combustion chamber; and a control means which starts the engine with normal operation in which the fuel injection device injects the fuel to all the cylinders or reduced-cylinder operation in which the fuel injection device injects the fuel to only specific cylinders, wherein, at the time of starting the engine, the control means performs the normal operation when the temperature in the combustion chamber calculated by the combustion chamber temperature calculation means is in a very-low-temperature range, and performs the reduced-cylinder operation when the temperature in the combustion chamber comes into a low-temperature range.

In the engine of the present invention, preferably, in the case that the normal operation is performed at the time of starting the engine, the control means performs the normal operation for a predetermined period and then performs the reduced-cylinder operation.

An engine of the present invention comprises: a plurality of cylinders; a fuel injection device which injects fuel to each of the cylinders; a combustion chamber temperature calculation means which calculates temperature in a combustion chamber; and a control means which calculates fuel injection amount, and starts the engine with normal operation in which the fuel injection device injects the fuel to all the cylinders or reduced-cylinder operation in which the fuel injection device injects the fuel to only specific cylinders, wherein at the time of starting the engine, the control means performs the normal operation when the temperature in the combustion chamber calculated by the combustion chamber temperature calculation means is in a very-low-temperature range, and performs the reduced-cylinder operation when the fuel injection amount at the normal operation becomes smaller than predetermined amount in the normal operation.

### Effect of the Invention

The engine according to the present invention can be started certainly in the very-low-temperature range.

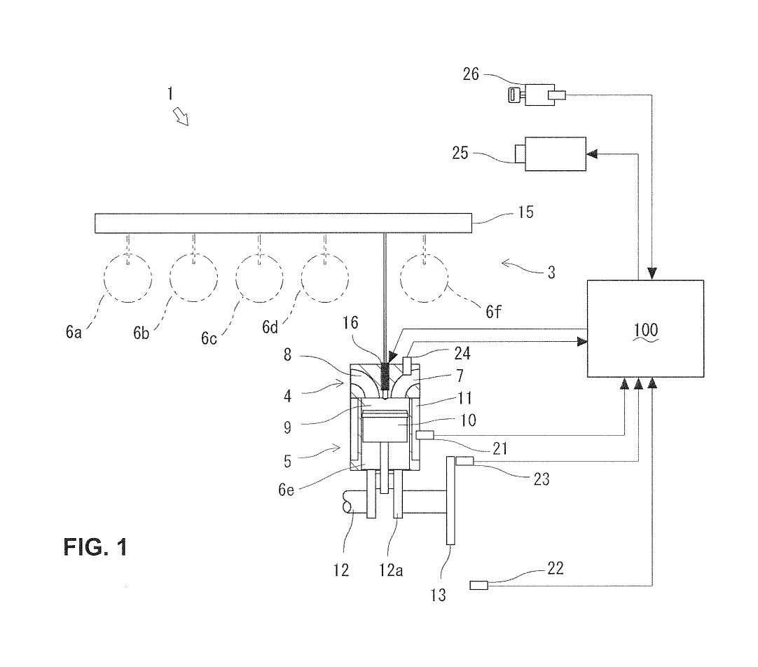

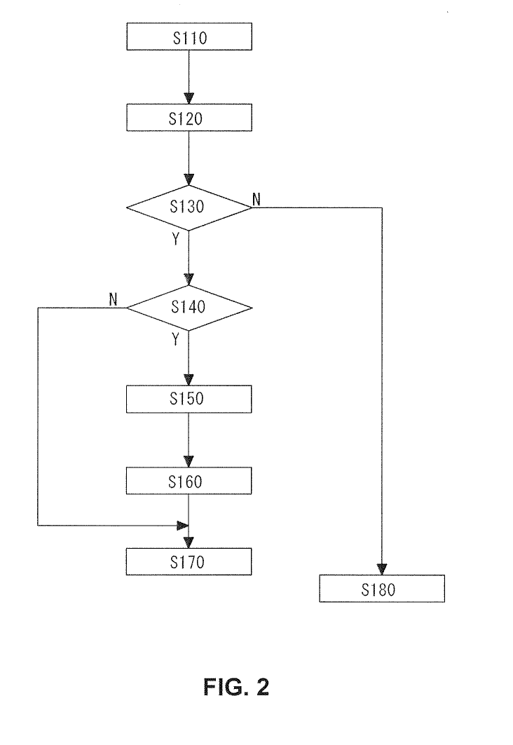

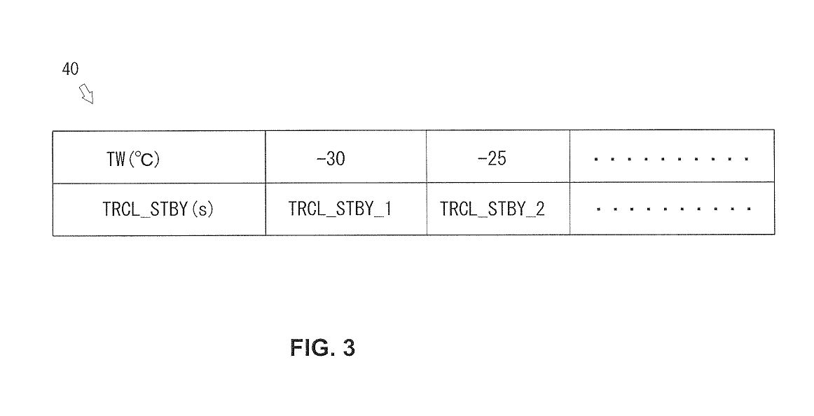

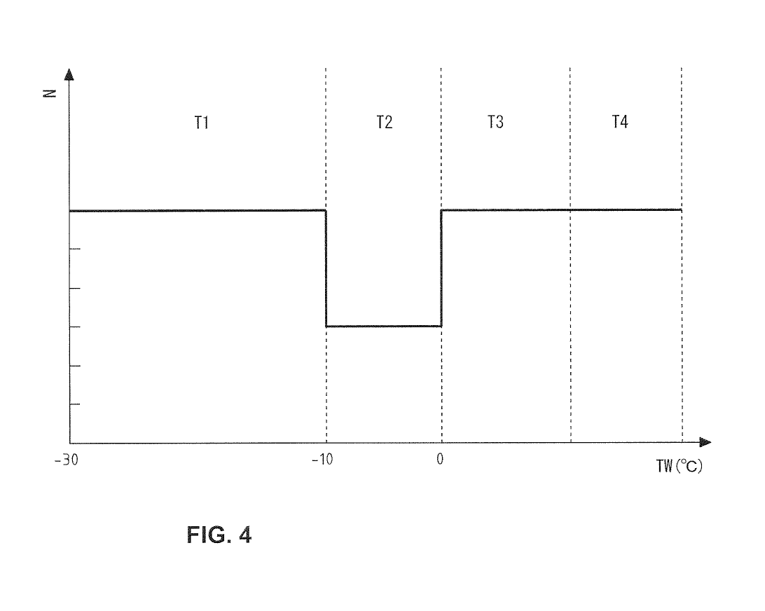

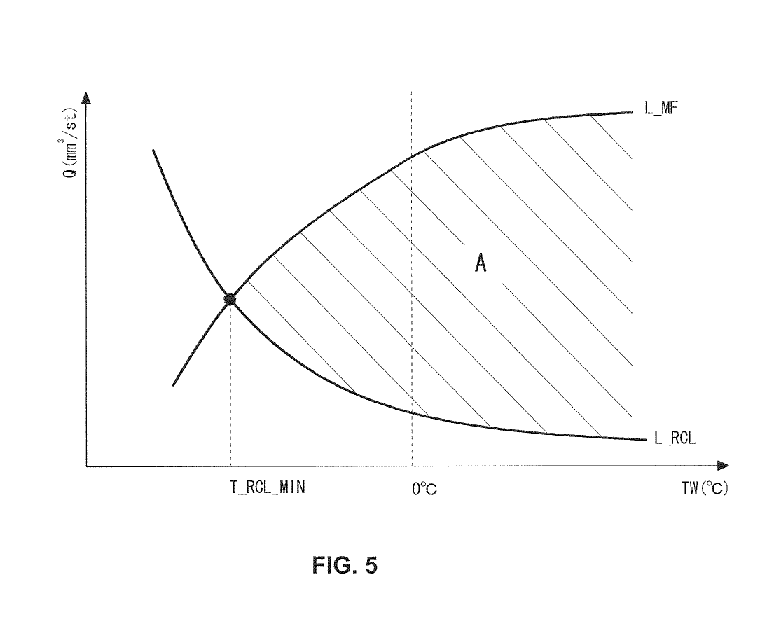

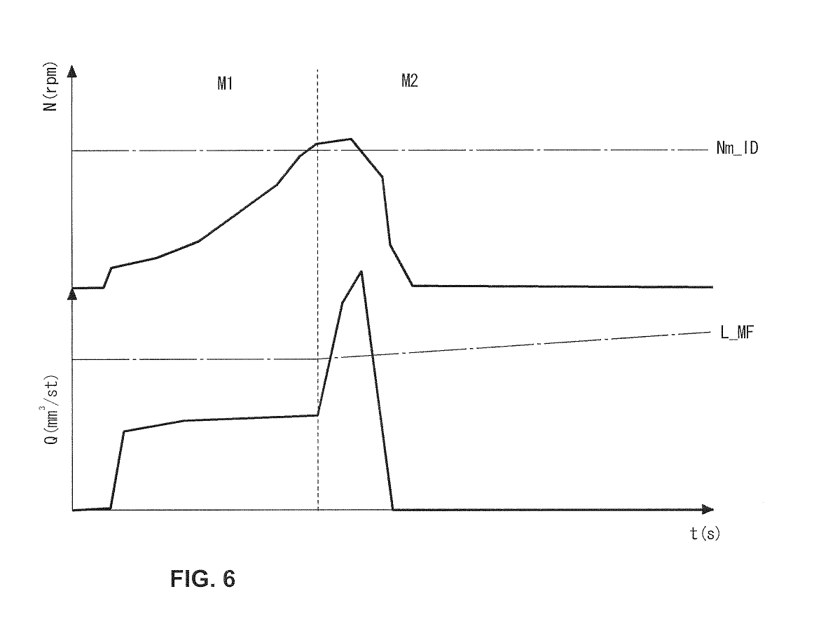

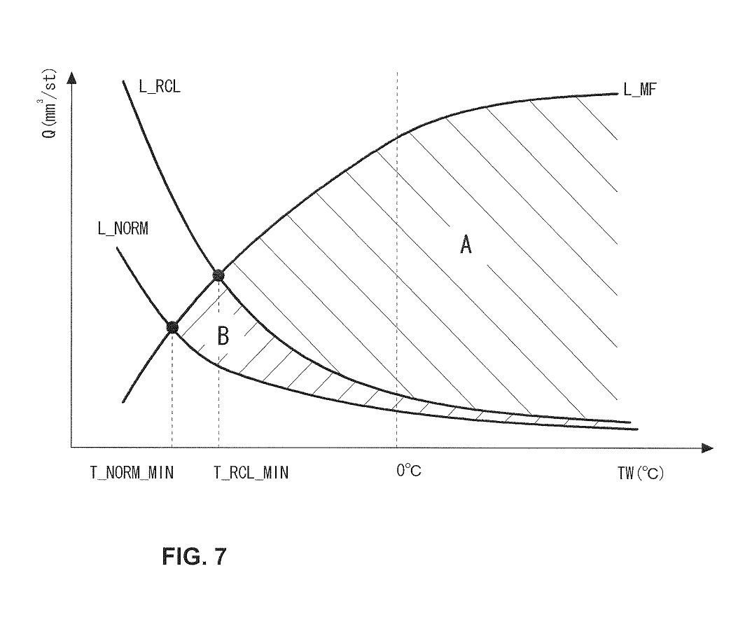

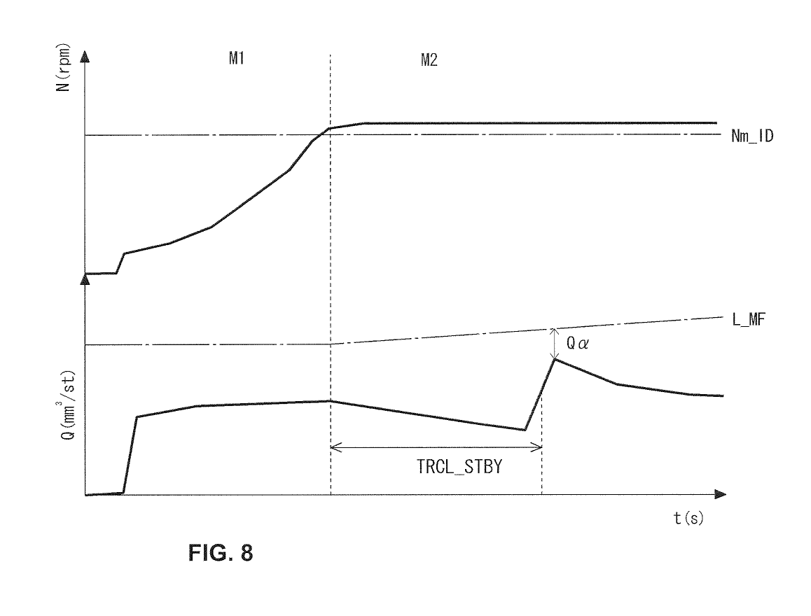

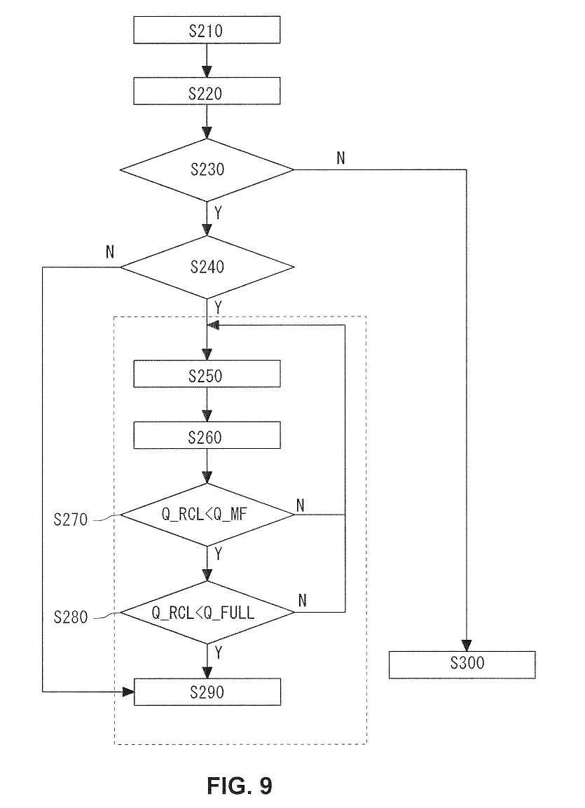

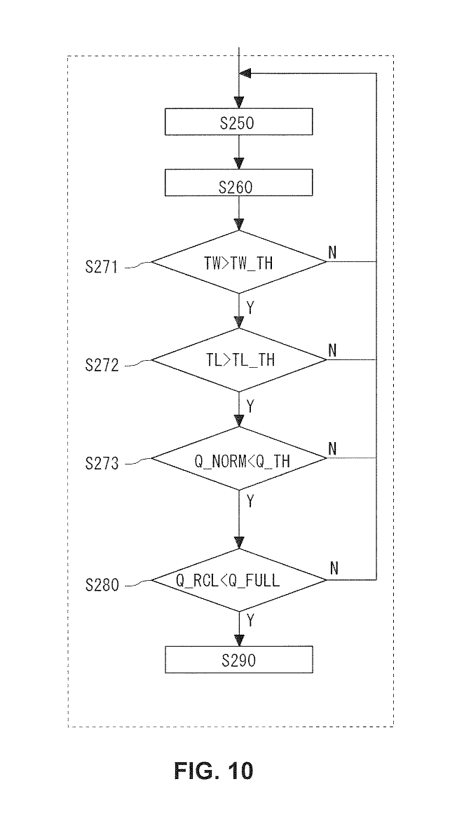

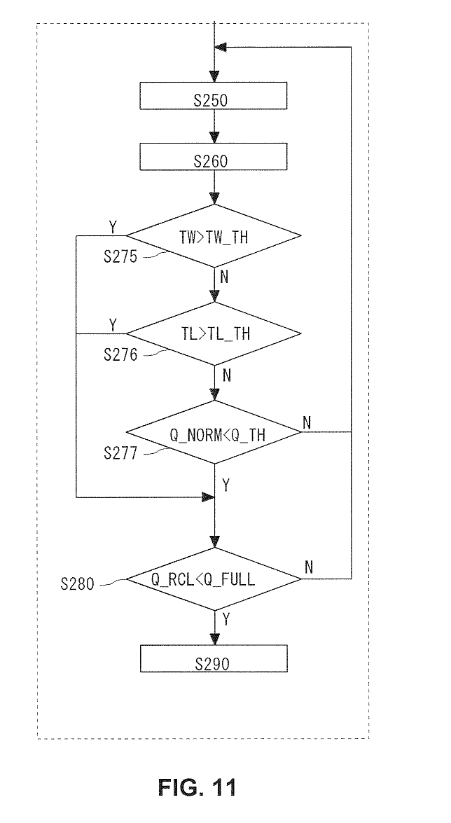

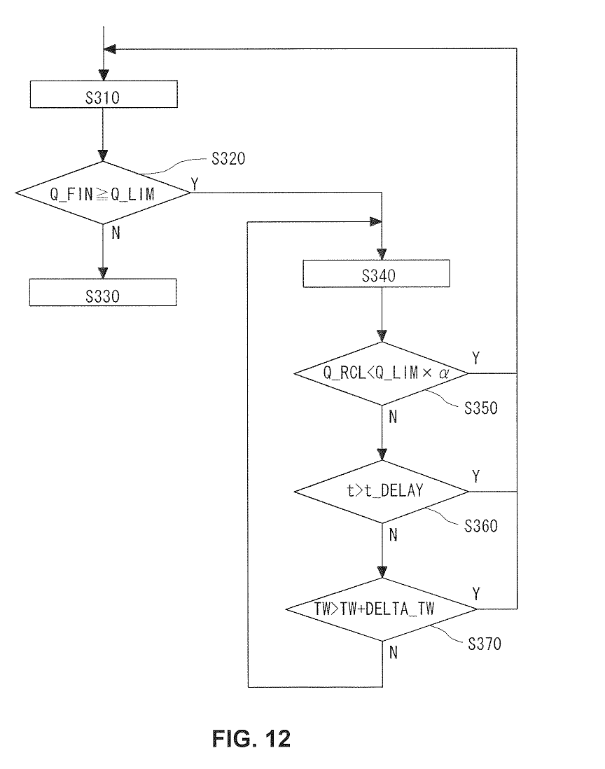

### BRIEF DESCRIPTION OF DRAWINGS

[FIG. 1] It is a schematic drawing of an engine according to an embodiment of the present invention.

[FIG. 2] It is a flow chart of starting control of the engine of the embodiment 1.

[FIG. 3] It is a table diagram of a TW map of the embodiment 1.

[FIG. 4] It is a table diagram of an outline of reduced-cylinder operation control of the embodiment 1.

[FIG. 5] It is a mapping diagram of a conventional starting limit.

[FIG. 6] It is a chart of behavior of conventional very-low-temperature limit starting.

[FIG. 7] It is a mapping diagram of a starting limit of the embodiment 1.

[FIG. 8] It is a chart of behavior of very-low-temperature limit starting of the embodiment 1.

[FIG. 9] It is a flow chart of starting control of the engine of the embodiment 2.

[FIG. 10] It is a flow chart of starting control of the engine of the embodiment 3.

[FIG. 11] It is a flow chart of starting control of the engine of the embodiment 4.

[FIG. 12] It is a flow chart of starting control of the engine of the embodiment 5.

### DETAILED DESCRIPTION OF THE INVENTION

Explanation will be given on construction of a diesel engine 1 which is an embodiment of the present invention referring FIG. 1. The diesel engine 1 is a direct-injection 6-cylindered diesel engine having six cylinders 6a, 6b, 6c, 6d, 6e and 6f. In FIG. 1, only one cylinder 6e is shown for simplifying the explanation.

The diesel engine 1 includes an engine body, a fuel injection device 3 and an ECU (Engine Control Unit) 100 as a control means. The engine body includes a cylinder head 4 and a cylinder block 5. The cylinder head 4 includes an intake manifold 7 and an exhaust manifold 8. The cylinder block 5 includes the cylinders 6a, 6b, 6c, 6d, 6e and 6f, a water jacket 11 and a crankshaft 12. The cylinder 6e includes a combustion chamber 9 and a piston 10.

The piston 10 is slid airtightly and reciprocated on the inner peripheral surface of the cylinder forming the combustion chamber 9.

The crankshaft 12 is connected through a connecting rod 12a to the piston 10 and is rotated by the reciprocation of the piston 10.

The water jacket 11 is a dual structure space through which engine cooling water cooling the combustion chamber 9 passes.

The fuel injection device 3 includes a supply pump (not shown), a common rail 15 and an injector 16. The common rail 15 is a vessel in which high-pressure fuel is accumulated by the supply pump. The injector 16 is a device injecting the high-pressure fuel accumulated in the common rail 15 to the combustion chamber 9.

The ECU 100 is connected to an engine cooling water temperature sensor 21, an engine lubricating oil temperature sensor 22, an engine rotation speed sensor 23, a supply air pressure sensor 24, a cell motor 25, a Key switch 26 and the injector 16.

The ECU 100 substitutes engine cooling water temperature TW or engine lubricating oil temperature TL for combustion chamber temperature which is difficult to be obtained directly.

The engine cooling water temperature sensor 21 as a combustion chamber temperature calculation means is provided in the water jacket 11 and detects the engine cooling water temperature TW as the combustion chamber temperature.

The engine lubricating oil temperature sensor 22 as the combustion chamber temperature calculation means is provided in an oil tank (not shown) and detects the engine lubricating oil temperature TL as the combustion chamber temperature.

The engine rotation speed sensor 23 is provided near a flywheel 13 fixed to the piston 10 and detects engine rotation speed N.

The supply air pressure sensor 24 is provided in the intake manifold 7 and detects supply air pressure Pb.

Engine starting signifies that the Key switch 26 is rotated to an ON position and the ECU 100 is started.

Low-temperature starting is the engine starting in the case that the combustion chamber temperature is in low temperature range (−10° C. to 0° C.).

Very-low-temperature starting is the engine starting in the case that the combustion chamber temperature is in very-low temperature range (−30° C. to −10° C.).

Reduced-cylinder operation is the operation that the ECU 100 stops fuel injection to the specific cylinders 6a, 6b and 6c. However, the cylinders to be stopped are not limited to the cylinders 6a, 6b and 6c.

Normal operation is the operation that fuel of predetermined amount is injected to each of the cylinders 6a, 6b, 6c, 6d, 6e and 6f at the timing the most efficient.

At starting mode, the ECU 100 drives the diesel engine 1 with the drive of the cell motor 25 and the fuel injection.

At idling operation mode, the ECU 100 drives the diesel engine 1 only with the fuel injection without the drive of the cell motor 25.

Waiting of the reduced-cylinder operation is the state that the reduced-cylinder operation is started when the combustion chamber temperature reaches the low temperature range or a predetermined condition is satisfied, and actually the normal operation is performed.

Return of the reduced-cylinder operation is that the reduced-cylinder operation is started from the state of waiting of the reduced-cylinder operation.

### Embodiment 1

Explanation will be given on engine starting control which is the embodiment 1 referring FIG. 2. The ECU 100 is started by starting the engine (S110). Next, the ECU 100 detects the engine cooling water temperature TW with the engine cooling water temperature sensor 21 (S120) and judges whether the state is one of very-low temperature starting and low temperature starting or not based on the engine cooling water temperature TW (S130). At this time, the ECU 100 performs the normal operation (S180) when the state is not one of very-low temperature starting and low temperature starting, and judges whether the state is the very-low temperature starting or low temperature starting when the state is one of very-low temperature starting and low temperature starting (S140). At this time, when the state is the low temperature starting, the ECU 100 performs the reduced-cylinder operation (S170). When the state is the very-low temperature starting, the ECU 100 calculates reduced-cylinder operation waiting time TRCL_STBY as the predetermined time (S150), and waits the reduced-cylinder operation for the reduced-cylinder operation waiting time TRCL_STBY (S160) and then starts the reduced-cylinder operation (S170).

Explanation will be given on a TW map 40 referring FIG. 3. The TW map 40 is stored in the ECU 100 previously. In the TW map 40, the reduced-cylinder operation waiting time TRCL_STBY (s) is determined which is the time for which the reduced-cylinder operation is supposed to be able to start at the low temperature starting. Namely, the ECU 100 can calculate the reduced-cylinder operation waiting time TRCL_STBY based on the engine cooling water temperature TW with the TW map 40.

Accordingly, after the reduced-cylinder operation waiting time TRCL_STBY passes for which the combustion chamber temperature becomes low at the waiting of the reduced-cylinder operation at the very-low temperature, the reduced-cylinder operation can be started. Then, when the combustion chamber temperature becomes low, cold smoke of the diesel engine 1 can be reduced efficiently.

Explanation will be given on the correlation of the engine cooling water temperature TW and the starting mode in the engine starting control which is the embodiment 1 referring a table in FIG. 4 (the axis of abscissas indicates the engine cooling water temperature TW (° C.), and the axis of ordinates indicates operated cylinder number N). The ECU 100 keeps the reduced-cylinder operation waiting, that is, performs the normal operation when the engine cooling water temperature TW is in very-low-temperature range T1, and starts the reduced-cylinder operation the engine cooling water temperature TW reaches low-temperature range T2. When the engine cooling water temperature TW reaches normal-temperature range T3 or warm-temperature range T4, the ECU 100 performs the normal operation.

Explanation will be given on the conventional low temperature starting limit referring a graph in FIG. 5 (the axis of abscissas indicates the engine cooling water temperature TW (° C.), and the axis of ordinates indicates fuel injection amount Q (mm³/st)). In the conventional engine starting control, even if the engine cooling water temperature TW is in the very-low-temperature range T1, the starting is performed with the reduced-cylinder operation. An area A is startable area of the conventional diesel engine 1. Lower limit temperature T_RCL_MIN is set as the low temperature starting limit of the engine cooling water temperature TW with the conventional reduced-cylinder operation. The area A is not more than a misfire limit line L_MF and not less than a fuel injection amount limit line (reduced-cylinder operation) L_RCL.

The misfire limit line L_MF shows the minimum fuel injection amount at which the misfire of the diesel engine 1 occurs. Herein, in the combustion chamber 9 of the diesel engine 1, heat of evaporation of the fuel causes a lot of heat loss. The latent heat of vaporization is increased depending on the fuel injection amount. Then, in the diesel engine 1, even if the fuel injection amount Q is fixed, the mixed air tends to be difficult to cause burning reaction following the reduction of the engine cooling water temperature TW, thereby causing the misfire. Accordingly, in the diesel engine 1, as shown by the misfire limit line L_MF, the minimum fuel injection amount at which the misfire is caused is reduced following the reduction of the engine cooling water temperature TW.

On the other hand, the fuel injection amount limit line (reduced-cylinder operation) L_RCL shows the fuel injection amount Q required for maintaining the idling rotation of the diesel engine 1 at the reduced-cylinder operation. Herein, in the diesel engine 1, the viscosity of the engine lubricating oil is increased so as to increase the friction following the reduction of the engine cooling water temperature TW. In the diesel engine 1, the heat loss of the combustion chamber 9 is also increased following the reduction of the engine cooling water temperature TW. Accordingly, in the diesel engine 1, as shown by the fuel injection amount limit line (reduced-cylinder operation) L_RCL, the fuel injection amount Q is increased following the reduction of the engine cooling water temperature TW.

Explanation will be given on the behavior of the conventional engine starting control referring a graph in FIG. 6 (the axis of abscissas indicates the time t (s), and the axis of ordinates indicates the engine rotation speed N (rpm) and the fuel injection amount Q (mm³/st)). In FIG. 6, an upper alternate long and short dash line indicates target idling rotation speed Nm_ID (rpm), and a lower alternate long and short dash line indicates the above-mentioned misfire limit line L_MF.

In the engine starting control, even if the engine cooling water temperature TW is in the very-low-temperature range T1, the starting is performed with the reduced-cylinder operation. In this case, in the diesel engine 1, at the moment of shifting from starting mode M1 to idling operation mode M2, the engine cooling water temperature TW is in the very-low-temperature range T1 so that the fuel injection amount Q required for maintaining the idling rotation is increased extremely, whereby the misfire causes engine failure.

Explanation will be given on the low-temperature starting limit of the diesel engine 1 of the embodiment 1 referring a graph in FIG. 7 (the axis of abscissas indicates the engine cooling water temperature TW (° C.), and the axis of ordinates indicates the fuel injection amount Q (mm³/st)).

In FIG. 7, the misfire limit line L_MF and the fuel injection amount limit line (reduced-cylinder operation) L_RCL are similar to those in FIG. 5, and so explanation thereof is omitted.

In the engine starting control of the embodiment 1, when the engine cooling water temperature TW is in the very-low-temperature range T1, the reduced-cylinder operation is kept waiting. Herein, in the reduced-cylinder operation, the fuel injection amount Q is higher than that in the normal operation. Then, following the reduction of the engine cooling water temperature TW, a fuel injection amount limit line (normal operation) L_NORM is reduced more than the fuel injection amount limit line (reduced-cylinder operation) L_RCL. Accordingly, in addition to the area A, the temperature starting limit area of the normal operation is extended to an area B.

Explanation will be given on the behavior of the engine starting control of the embodiment 1 referring a graph in FIG. 8 (t n he axis of abscissas indicates the time t (s), and the axis of ordinates indicates the engine rotation speed N (rpm) and the fuel injection amount Q (mm³/st)). In FIG. 8, the target idling rotation speed Nm_ID (rpm) and the misfire limit line L_MF are similar to those in FIG. 6.

Since the reduced-cylinder operation is kept waiting for the reduced-cylinder operation waiting time TRCL_STBY, the fuel injection amount Q is lower than that at the reduced-cylinder operation. Then, the diesel engine 1 can be started certainly at the very-low-temperature range T1. The reduced-cylinder operation can be started after the friction of the diesel engine 1 is reduced. Accordingly, at the time of starting the reduced-cylinder operation, the misfire margin of the diesel engine 1 (Qα in the drawing) can be secured.

### Embodiment 2

Explanation will be given on engine starting control which is the embodiment 2 referring FIG. 9. The ECU 100 is started by starting the engine (S210). The ECU 100 detects the engine cooling water temperature TW (S220) and judges whether the state is one of very-low temperature starting and low temperature starting or not (S230). At this time, when the state is not one of very-low temperature starting and low temperature starting, the ECU 100 performs the normal operation (S300), and when the state is one of very-low temperature starting and low temperature starting, the ECU 100 judges whether the state is the very-low temperature starting or low temperature starting (S240). Next, when the state is the very-low temperature starting at the step S240, the reduced-cylinder operation is kept waiting (S250).

Next, the ECU 100 calculates normal fuel injection amount Q_NORM for the case of the normal operation, and calculates reduced-cylinder assumed fuel injection amount Q_RCL for the case of the reduced-cylinder operation based on the normal fuel injection amount Q_NORM (S260). The ECU 100 calculates misfire limit fuel injection amount Q_MF based on the engine cooling water temperature TW, and judges whether the reduced-cylinder assumed fuel injection amount Q_RCL is smaller than the misfire limit fuel injection amount Q_MF or not (S270). When Q_RCL is not smaller at the step S270, the ECU 100 keeps the reduced-cylinder operation waiting (S250).

Next, the ECU 100 calculates the maximum fuel injection amount Q_FULL of the normal fuel injection amount Q_NORM based on the engine rotation speed N and the supply air pressure Pb, and judges whether the reduced-cylinder assumed fuel injection amount Q_RCL is smaller than the maximum fuel injection amount Q_FULL (S280). When Q_RCL is not smaller at the step S280, the ECU 100 keeps the reduced-cylinder operation waiting (S250). When Q_RCL is smaller at the step S280, the reduced-cylinder operation is started (S290).

Accordingly, at the time of waiting of the reduced-cylinder operation at the very-low temperature, when the reduced-cylinder assumed fuel injection amount Q_RCL is smaller than the misfire limit fuel injection amount Q_MF, the return of the reduced-cylinder operation is performed. Then, the cold smoke of the diesel engine 1 can be reduced effectively. At this time, the reduced-cylinder assumed fuel injection amount Q_RCL assumed in the reduced-cylinder operation is substituted for the combustion chamber temperature which is difficult to be obtained directly. Accordingly, the diesel engine 1 can be returned to the reduced-cylinder operation at proper timing. The fuel injection amount in the reduced-cylinder operation can be limited not more than the maximum fuel injection amount Q_FULL in the normal operation based on the supply air pressure Pb. Accordingly, generation of black smoke of the diesel engine 1 can be prevented.

### Embodiment 3

Explanation will be given on engine starting control which is the embodiment 3 referring FIG. 10. The embodiment 3 is the control that the steps S250 to S290 of the embodiment 2 are changed. When the state is the very-low temperature starting, the ECU 100 keeps the reduced-cylinder operation waiting (S250) and calculates the reduced-cylinder assumed fuel injection amount Q_RCL (S260).

The ECU 100 judges whether the engine cooling water temperature TW is larger than predetermined temperature TW-TH or not (S271). When TW is not larger at the step S271, the reduced-cylinder operation is kept waiting (S250). On another hand, the ECU 100 judges whether the engine lubricating oil temperature TL is larger than predetermined temperature TL-TH or not (S272). When TL is not larger at the step S272, the reduced-cylinder operation is kept waiting (S250). On another hand, the ECU 100 judges whether the normal fuel injection amount Q_NORM is smaller than predetermined amount Q_TH or not (S273). When TW is not smaller at the step S273, the reduced-cylinder operation is kept waiting (S250). On the other hand, each of the conditions in the steps S271, S272 and S273 is satisfied, the ECU 100 performs the reduced-cylinder operation via the step S280 (S290).

Namely, in the embodiment 3, when at least one of the engine cooling water temperature TW, the engine lubricating oil temperature TL and the normal fuel injection amount Q_NORM does not satisfy the predetermined condition, the diesel engine 1 cannot be returned to the reduced-cylinder operation.

### Embodiment 4

Explanation will be given on engine starting control which is the embodiment 4 referring FIG. 11. The embodiment 4 is the control that the steps S250 to S290 of the embodiment 2 are changed. When the state is the very-low temperature starting, the ECU 100 keeps the reduced-cylinder operation waiting (S250) and calculates the reduced-cylinder assumed fuel injection amount Q_RCL (S260).

The ECU 100 judges whether the engine cooling water temperature TW is larger than predetermined temperature TW-TH or not (S275). When TW is larger at the step S275, the reduced-cylinder operation is performed via the step S280 (S290). On another hand, the ECU 100 judges whether the engine lubricating oil temperature TL is larger than predetermined temperature TL-TH or not (S276). When TL is larger at the step S276, the reduced-cylinder operation is performed through the step S280 (S290). On another hand, the ECU 100 judges whether the normal fuel injection amount Q_NORM is smaller than predetermined amount Q_TH or not (S277). When TW is not smaller at the step S277, the reduced-cylinder operation is performed through the step S280 (S290). On the other hand, at least one of the conditions in the steps S275, S276 and S277 is not satisfied, the ECU 100 keeps the reduced-cylinder operation waiting (S250).

Namely, in the embodiment 4, when at least one of the engine cooling water temperature TW, the engine lubricating oil temperature TL and the normal fuel injection amount Q_NORM satisfies the predetermined condition, the diesel engine 1 can be returned to the reduced-cylinder operation.

### Embodiment 5

Explanation will be given on engine starting control which is the embodiment 5 referring FIG. 12. The ECU 100 starts the reduced-cylinder operation (S310), and judges whether reduced-cylinder fuel injection amount Q_FIN is not less than predetermined amount Q_LIM or not (S320). When Q_FIN is less than the predetermined amount Q_LIM at the step S320, the reduced-cylinder operation is continued (S330).

On another hand, when Q_FIN is not less than the predetermined amount Q_LIM at the step S320, the ECU 100 keeps the reduced-cylinder operation waiting (S340). Next, the ECU 100 judges whether the reduced-cylinder assumed fuel injection amount Q_RCL is smaller than the product of the fuel injection limit amount Q_LIM at the reduced-cylinder operation and predetermined ratio α or not (S350). When Q_RCL is smaller at the step S350, the reduced-cylinder operation is started (S310). The ECU 100 judges whether predetermined time t_DELAY passes from the time t at which the reduced-cylinder operation is kept waiting or not (S360). When t_DELAY passes at the step S360, the reduced-cylinder operation is started (S310). The ECU 100 judges whether the engine cooling water temperature TW is increased for predetermined temperature TW_DELTA from the engine cooling water temperature TW at the waiting of the reduced-cylinder operation or not (S370). When TW is increased at the step S370, the reduced-cylinder operation is started (S310).

On the other hand, at least one of the conditions in the steps S350, S360 and S370 is not satisfied, the ECU 100 keeps the reduced-cylinder operation waiting (S310).

Accordingly, at the reduced-cylinder operation, when the reduced-cylinder fuel injection amount Q_FIN is not less than the predetermined amount Q_LIM, the reduced-cylinder operation of the diesel engine 1 is kept waiting. Then, generation of black smoke of the diesel engine 1 can be prevented certainly.

### INDUSTRIAL APPLICABILITY

The present invention is adoptable to a diesel engine which performs reduced-cylinder operation.

1. An engine comprising:
a plurality of cylinders;
a fuel injection device which injects fuel to each of the cylinders;
a combustion chamber temperature calculation means which calculates temperature in a combustion chamber; and
a control means which starts the engine with normal operation in which the fuel injection device injects the fuel to all the cylinders or reduced-cylinder operation in which the fuel injection device injects the fuel to only specific cylinders,
wherein, at the time of starting the engine, the control means performs the normal operation when the temperature in the combustion chamber calculated by the combustion chamber temperature calculation means is in a very-low-temperature range, and performs the reduced-cylinder operation when the temperature in the combustion chamber comes into a low-temperature range.

2. The engine according to claim 1, wherein in the case that the normal operation is performed at the time of starting the engine, the control means performs the normal operation for a predetermined period and then performs the reduced-cylinder operation.

3. An engine comprising:
a plurality of cylinders;
a fuel injection device which injects fuel to each of the cylinders;
a combustion chamber temperature calculation means which calculates temperature in a combustion chamber; and
a control means which calculates fuel injection amount, and starts the engine with normal operation in which the fuel injection device injects the fuel to all the cylinders or reduced-cylinder operation in which the fuel injection device injects the fuel to only specific cylinders,
wherein at the time of starting the engine, the control means performs the normal operation when the temperature in the combustion chamber calculated by the combustion chamber temperature calculation means is in a very-low-temperature range, and performs the reduced-cylinder operation when the fuel injection amount at the normal operation becomes smaller than predetermined amount in the normal operation.
